(19) United States
(12) Patent Application Publication
(10) Pub. No.: US 2010/0206819 A1
(43) Pub. Date: Aug. 19, 2010

(54) FLUID TREATMENT ELEMENTS AND FLUID TREATMENT ARRANGEMENTS WITH FLUID TREATMENT ELEMENTS HAVING UNEVEN SURFACES AND METHODS FOR MAKING AND USING THEM

(75) Inventors: Thomas Welch, JR., Homer, NY (US); Stephen Geibel, Cortland, NY (US); Tanweer ul Haq, Tully, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, Port Washington, NY (US)

(21) Appl. No.: 12/531,708

(22) PCT Filed: Mar. 14, 2008
(86) PCT No.: PCT/US08/57007

§ 371 Date: Apr. 14, 2010

Related U.S. Application Data
(60) Provisional application No. 60/907,065, filed on Mar. 19, 2007.

(51) Int. Cl. B01D 29/21; B01D 29/48; B01D 29/54; B01D 46/00; B23P 17/00

(52) U.S. Cl. 210/767; 210/488; 210/437; 210/494.1; 29/890.14

(57) ABSTRACT

Fluid treatment arrangements and elements and methods for making and using fluid treatment arrangements and elements are disclosed. A ribbon including a permeable fluid treatment medium may be spirally wound in a plurality of windings to form a fluid treatment element having a disk-shaped body. The disk-shaped body may have first and second opposite end surfaces, e.g., an inflow surface and an outflow surface, and an outer rim. One or both of the end surfaces may be an uneven surface. At least two and as many as many as fifty or more fluid treatment elements may be positioned along a hollow core assembly. Fluid may be directed to or from the interior of the core assembly through each fluid treatment element. In each fluid treatment element, fluid flows from the inflow surface to the outflow surface generally edgewise through the permeable fluid treatment medium.

This application claims priority based on U.S. Provisional Application No. 60/907,065, which was filed on Mar. 19, 2007, and is incorporated by reference.

### DISCLOSURE OF THE INVENTION

The present invention relates to fluid treatment arrangements and elements and to methods for making and using them. In particular, the present invention relates to fluid treatment arrangements and methods for making and using fluid treatment arrangements which include one or more spirally wound fluid treatment elements. A fluid treatment element may be fashioned by spirally winding a ribbon in a plurality of windings to form a generally disk-shaped body. The ribbon may include a long, narrow strip of a permeable fluid treatment medium having first and second opposite major surfaces and first and second opposite side edges. The disk-shaped body may have an end surface, e.g., an inflow surface, which faces in one direction, another end surface, e.g., an outflow surface, which faces in the opposite direction, and an outer rim. To form a fluid treatment arrangement, several of these fluid treatment elements may be positioned along a hollow core assembly with a space between at least some of the elements.

A fluid may be directed through a fluid treatment element, i.e., from the inflow surface to the outflow surface of the fluid treatment element. As the fluid passes through the fluid treatment element, the fluid may pass generally edgewise through the permeable fluid treatment medium of each winding, i.e., the fluid may flow generally laterally within the permeable medium generally parallel to the first and second opposite major surfaces. The fluid may also flow radially from the permeable fluid treatment medium of one winding into and then laterally along the permeable medium of one or more adjacent or nearby windings.

Fluid treatment arrangements embodying one or more aspects of the invention may be used to treat fluids, including gases, liquids, or mixtures of gases, liquids, and/or solids. As the fluid passes through the fluid treatment element, the fluid may be treated in any of numerous ways, depending on the fluid treatment characteristic of the fluid treatment element, and there are many different fluid treatment characteristics. For example, the fluid treatment characteristic may relate to a pore structure or a removal rating of the fluid treatment medium which retards or prevents passage of particulates or molecules above a certain size and filters these particulates or molecules from the fluid as the fluid flows through the fluid treatment element. As another example, the fluid treatment characteristic may relate to a chemical or biochemical agent on or in the fluid treatment medium which binds to one or more substances, e.g., molecules, proteins, and/or nucleic acids, in the fluid and separates these substances from the fluid as the fluid flows through the fluid treatment element. As yet another example, the fluid treatment characteristic may relate to a sorbent material in or on the fluid treatment medium which absorbs or adsorbs one or more substances, e.g., molecules or compounds, from the fluid and separates these substances from the fluid as the fluid flows through the fluid treatment element. As a further example, the fluid treatment characteristic may relate to a surface chemistry of the fluid treatment medium which aggregates small droplets of liquid entrained in the fluid and produces larger droplets that may be more easily removed from the fluid.

### SUMMARY OF THE INVENTION

In accordance with one aspect of the invention, fluid treatment arrangements may comprise a hollow core assembly, first and second fluid treatment elements mounted along the core assembly, and a fluid flow path. The hollow core assembly has an interior. Each fluid treatment element includes a ribbon having a permeable fluid treatment medium. The ribbon is spirally wound around the core assembly in a plurality of windings to define a disk-shaped body having a first end surface on one side of the disk-shaped body, a second end surface on the opposite side of the disk-shaped body, and an outer rim. At least one end surface of at least one fluid treatment element includes an uneven surface. The fluid flow path extends between the first and second end surfaces of each fluid treatment element generally edgewise through the permeable fluid treatment medium to or from the interior of the core assembly.

In accordance with another aspect of the invention, fluid treatment elements may comprise a disk-shaped body and a fluid pathway. The disk-shaped body includes a ribbon having a permeable fluid treatment medium, first and second opposite major surfaces, and first and second opposite side edges. The ribbon is spirally wound in a plurality of windings to form the disk-shaped body. The disk-shaped body has a first end surface on one side of the body, a second end surface on the opposite side of the body, and an outer rim. At least one of the first and second end surfaces includes an uneven surface which includes a plurality of windings of one of the first and second side edges of the ribbon. The fluid pathway extends between the first and second end surfaces of the disk-shaped body generally edgewise through the permeable medium.

In accordance with another aspect of the invention, methods of making a fluid treatment element may comprise spirally winding a ribbon having a permeable fluid treatment medium in a plurality of windings to form a disk-shaped body. The disk-shaped body has a first end surface, a second end surface opposite the first end surface, and an outer rim. Spirally winding the ribbon includes forming at least one of the first and second end surfaces to include an uneven surface.

In accordance with another aspect of the invention, methods of making a fluid treatment arrangement may comprise forming a plurality of fluid treatment elements by spirally winding a plurality of ribbons in a plurality of windings to form disk-shaped bodies. Each ribbon has a permeable fluid treatment medium, and each disk-shaped body has first and second opposite end surfaces and an outer rim. Forming the plurality of fluid treatment elements includes forming at least one end surface of at least one fluid treatment element to include an uneven surface. The methods of making a fluid treatment arrangement may further comprise axially positioning the fluid treatment elements along a hollow core assembly.

In accordance with another aspect of the invention, methods of treating a fluid may comprise passing fluid through at least one fluid treatment element including a disk-shaped body from a first end surface on one side of the body to a second end surface on the opposite side of the body. At least one of the first and second end surfaces includes an uneven surface, and passing the fluid through the fluid treatment element includes directing the fluid into or out of the uneven surface. Passing the fluid through the fluid treatment element further includes passing the fluid generally edgewise through a permeable fluid treatment medium of a ribbon spirally wound in a plurality of windings to form the disk-shaped body.

In accordance with another aspect of the invention, fluid treatment elements may comprise a disk-shaped body which includes a ribbon having a permeable fluid treatment medium. The ribbon may be spirally wound in a plurality of windings to form the disk-shaped body. The permeable fluid treatment medium may have first and second opposite major surfaces, first and second opposite side edges, and a side edge portion which is fringed or frizzed and extends along at least one of the first and second side edges. The disk-shaped body may include a first end surface on one side of the body, a second end surface on the opposite side of the body, an inner rim, and an outer rim. The first end surface may include the plurality of windings of the first side edge of the permeable fluid treatment medium. The second side edge may include the plurality of windings of the second side edge of the permeable fluid treatment medium.

Embodiments of the invention have many advantages. For example, fluid treatment elements having an inflow surface which is an uneven surface and/or having a fluid treatment medium with a fringed or frizzed side edge portion have a particularly high dirt capacity and/or service life. Consequently, the elements may be replaced less frequently, providing both better economy and less waste. In addition, fluid treatment elements having an inflow surface and/or an outflow surface which is an uneven surface and/or having a fluid treatment medium with a fringed or frizzed side edge portion allow a more expansive flow of fluid to or from the end surfaces of the element, especially when the elements are in close proximity to one another. The uneven surfaces may provide channels that more evenly distribute the fluid over the entire inflow surface and/or more evenly drain the fluid from the entire outflow surface of the fluid treatment element. Consequently, more of the fluid treatment medium may be effectively utilized to treat the fluid.

### BRIEF DESCRIPTION OF THE DRAWINGS

FIG. 1 is a quarter sectioned view of a fluid treatment arrangement.

FIG. 2 is a front view of a fluid treatment element of FIG. 1.

FIG. 2a is a more detailed view of the uneven surface of the fluid treatment element of FIG. 2.

FIGS. 3A-3C are oblique views of three ribbons.

FIG. 4 is a front view of another fluid treatment element.

FIG. 4a is a more detailed view of the uneven surface of the fluid treatment element of FIG. 4.

FIG. 5 is a front view of another fluid treatment element.

FIG. 5a is a more detailed view of the uneven surface of the fluid treatment element of FIG. 5.

FIG. 6 is a front view of another fluid treatment element.

FIG. 6a is a more detailed view of the uneven surface of the fluid treatment element of FIG. 6.

FIG. 7A is a top view of two adjacent windings of a disk-shaped body formed by spirally winding the ribbon of FIG. 3A.

FIG. 7B is a cross sectional view of the windings of FIG. 7A.

FIG. 8 is a cross sectional view of several windings of a disk-shaped body.

FIGS. 9A and 9B are cross sectional views of several windings of disk-shaped bodies.

FIG. 10 is a quarter sectioned view of a fluid treatment assembly including a fluid treatment arrangement having a surround.

FIG. 11 is a quarter sectioned view of another fluid treatment assembly.

FIG. 12 is a sectioned view of a portion of another fluid treatment arrangement.

FIG. 13 is a sectional view of a portion of another fluid treatment arrangement.

FIGS. 14A and 14B are top views of ribbons.

### DESCRIPTION OF EMBODIMENTS

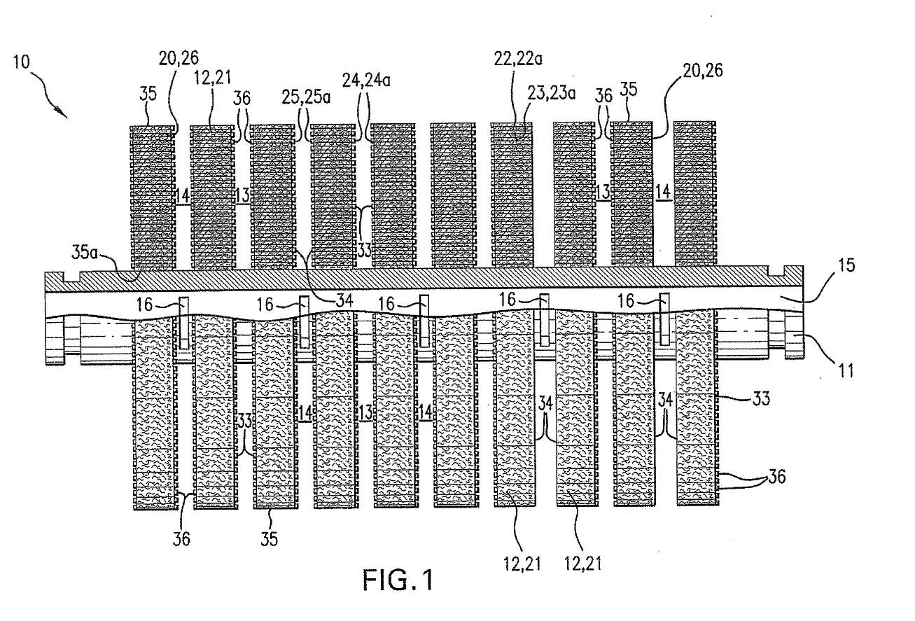

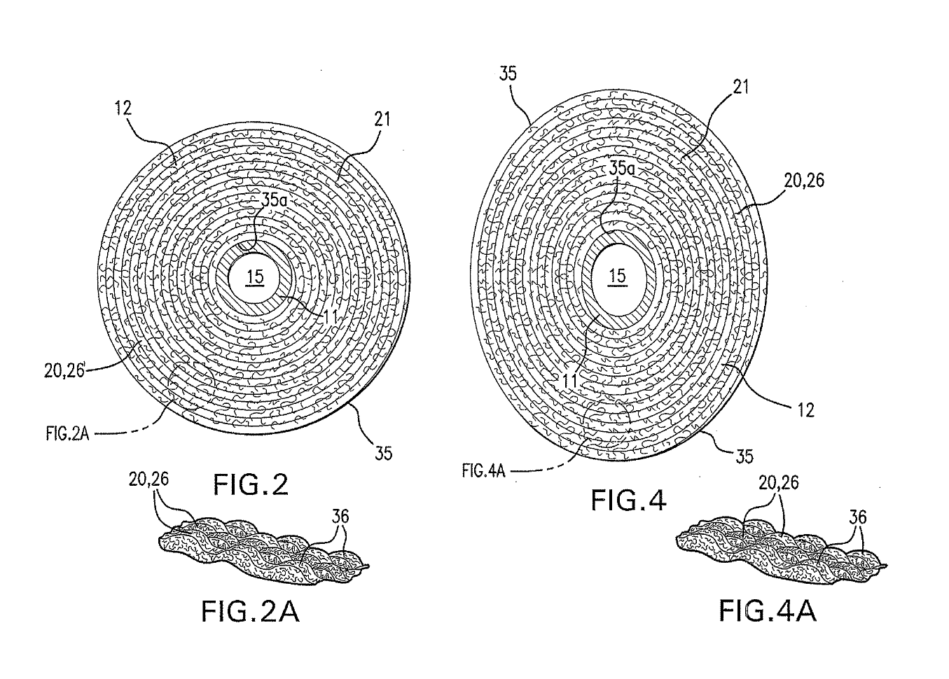

Fluid treatment arrangements embodying one or more aspects of the invention may be configured in a wide variety of ways. One example of a fluid treatment arrangement is shown in FIGS. 1 and 2, but fluid treatment arrangements are not limited to the features illustrated in either of these figures. As shown in FIGS. 1 and 2, a fluid treatment arrangement 10 may comprise a core assembly 11 and a plurality of spirally wound fluid treatment elements 12 positioned along the core assembly 11. The widths and/or radial dimensions of the fluid treatment elements 12 may be similar, e.g., substantially equal, or they may vary along the core assembly 11. Some of the fluid treatment elements 12 may be positioned along the core assembly axially separated from one another to define spaces 13, 14 between adjacent fluid treatment elements. Some of the fluid treatment elements may be axially positioned along the core assembly side-by-side in close proximity to, e.g., in contact with, one another along an interface.

The core assembly 11 may comprise a core, such as a pipe or a tube, having an axis and a generally hollow configuration, including an interior 15. The core assembly 11 may have two open ends or an open end and a closed or blind end. The core assembly 11 may also have openings 16, e.g., axially separated openings such as slots or other perforations, which allow some of the spaces 14 to fluidly communicate with the interior 15 of the core assembly 11. The spaces 14 that fluidly communicate with the interior 15 of the core assembly 11 may be fluidly isolated in a variety of ways from the exterior of the fluid treatment elements 12, e.g., the region radially beyond the fluid treatment elements. Other spaces 13 may be fluidly isolated from the interior 15 of the core assembly 11, for example, by a solid wall portion of the core assembly 11 which has no openings and which extends across and blocks the inner end of the space, and these spaces 13 may fluidly communicate with the exterior of the fluid treatment elements 12. Still other spaces may be isolated from both the interior of the core and the exterior of the fluid treatment elements.

Fluid may be directed generally inwardly or outwardly along a fluid flow path through the fluid treatment elements 12 between the interior 15 of the core assembly 11 and the exterior of the fluid treatment arrangement 10, e.g., the region radially beyond the fluid treatment arrangement. For example, for many embodiments, including the embodiment illustrated in FIG. 1, a feed fluid may be directed along a fluid flow path from the exterior of the fluid treatment arrangement 10 generally radially inwardly into feed spaces 13 which fluidly communicate with the exterior of the fluid treatment arrangement 10 but are isolated from the interior 15 of the core assembly 11. From the feed spaces 13, the fluid may flow generally axially along the fluid flow path through one or more fluid treatment elements 12 into permeate spaces 14 which are fluidly isolated from the exterior of the fluid treatment elements 12 but which fluidly communicate with the interior 15 of the core assembly 11 via the openings 16 in the core assembly 11. As the fluid flows through the fluid treatment elements 12, the fluid may be treated according to the fluid treatment characteristics of the elements. From the permeate spaces 14, the fluid may flow along the fluid flow path generally radially inwardly into and axially along the interior 15 of the core assembly 11.

Alternatively, the feed fluid may be directed into the interior of the core assembly and radially outwardly along a fluid flow path from the interior of the core assembly through the openings in the core assembly into feed spaces which are fluidly isolated from the exterior of the fluid treatment arrangement. From the feed spaces, the fluid may flow axially along the fluid flow path through the fluid treatment elements and into permeate spaces which are fluidly isolated from the interior of fluid treatment arrangement but which fluidly communicate with the exterior of the fluid treatment arrangement. From the permeate spaces, the fluid may flow outwardly along the flow path to the exterior of the fluid treatment arrangement.

In some embodiments, the fluid may flow along the fluid flow path through only one fluid treatment element. In other embodiments, the fluid may flow along the flow path between the exterior of the fluid treatment arrangement and the interior of the core assembly through more than one fluid treatment element, e.g., two, three, four, five, or more fluid treatment elements, and each fluid treatment element may have the same or a different fluid treatment characteristic.

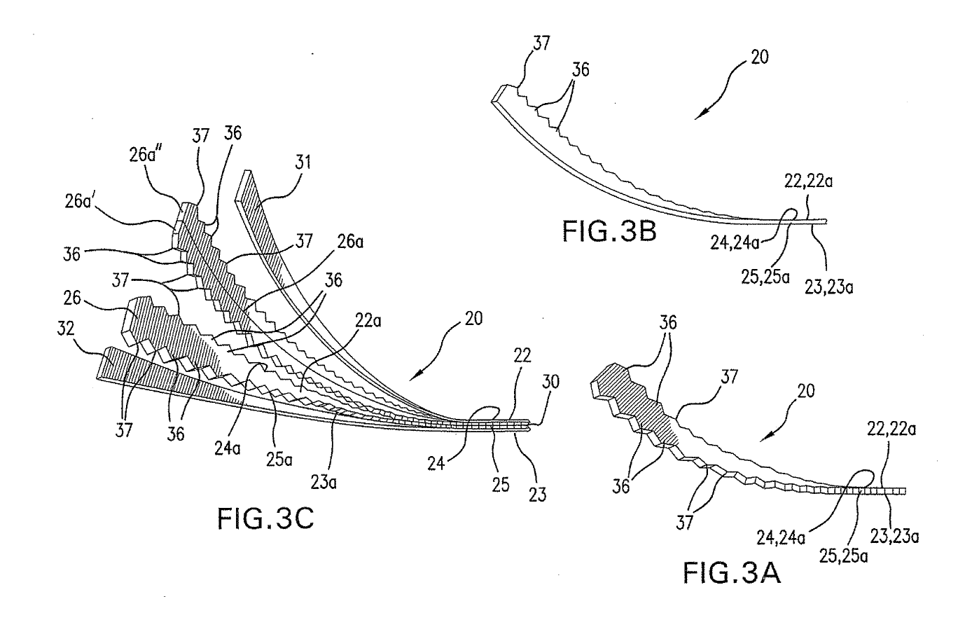

An example of a fluid treatment element 12 is shown in FIG. 2, but fluid treatment elements are not limited to the features illustrated in this figure. As shown in FIG. 2, the fluid treatment element 12 may comprise a ribbon 20 which is spirally wound in a plurality of windings to form a generally disk-shaped body 21. Ribbons may be configured in a wide variety of ways. Examples of various ribbons are shown in FIGS. 3A-3C, but ribbons are not limited to the features illustrated in these figures. Each ribbon 20 may have a long, narrow configuration with opposite major surfaces 22, 23 and opposite side edges 24, 25. The ribbon 20 includes at least one strip of a permeable fluid treatment medium 26 which also has opposite major surfaces 22a, 23a and opposite side edges 24a, 25a. The ribbon 20 including the porous fluid treatment medium may be permeable but unperforated, i.e., free of any through holes or through slots which extend between the opposite major surfaces 22, 23; 22a, 23a.

The permeable fluid treatment medium may be formed from any of numerous materials, including, for example, a natural or synthetic polymer, glass, metal, carbon, and/or ceramic. The permeable fluid treatment medium may be formed from any of a variety of structures, including, for example, fibrous structures, such as woven or non-woven fibrous strips; meshes, such as woven, extruded, or expanded mesh strips; permeable membranes, such as supported or unsupported membrane strips; porous foam strips; or porous metals, such as porous sintered fiber metal or powder metal strips.

The permeable fluid treatment medium may have any of a myriad of treatment characteristics. For example, the permeable fluid treatment medium may have, or may be modified to have, any of several fluid treatment characteristics including, without limitation, a positive or negative electrical charge; a liquiphobic or liquiphilic surface characteristic, including, for example, a hydrophobic or hydrophilic or oleophobic or oleophilic surface characteristic; attached functional groups, such as ligands or any other reactive moiety, that can chemically bind to substances in the fluid; or incorporated functional materials that may chemically or physically bind to, react with, catalyze, deliver, or otherwise affect substances within the fluid and/or the fluid itself, including, without limitation, sorbents, reactants, catalysts, and chromatography media of all types. More specifically, the functional material may include activated carbon, silica, zeolite, molecular sieves, clay, alumina, sodium bicarbonate, ion exchange resins, catalytic agents, metal oxides, oxidizing agents, reducing agents, buffering agents, biocidal agents, fungicidal agents, viricidal agents, air freshening agents, and perfuming agents. The functional material may be incorporated in the fluid treatment medium, e.g., bonded to, coated on, immobilized in, and/or formed as the fluid treatment medium. For some embodiments, the functional material may be in the form of particles or fibers immobilized in the fluid treatment medium. Further, a fluid treatment characteristic of the permeable fluid treatment medium may include any of a wide range of removal ratings or pore structures, including, for example, from ultraporous or nanoporous or finer to microporous or coarser. For example, the fluid treatment characteristic may include a removal rating in the submicron range or finer, e.g., up to about 0.02 μm or coarser or up to about 0.1 μm or coarser, or in the micron range or coarser, e.g., up to about 1 μm or coarser, or about 5 μm or coarser, or about 10 μm or coarser, or about 50 μm or coarser, or about 75 μm or coarser, or about 100 μm or coarser, or about 200 μm or coarser, or about 300 μm or coarser, or about 500 μm or coarser, or about 1000 μm or coarser. For many embodiments, at least one of the permeable fluid treatment media may comprise a filter medium of non-woven polymeric or glass fibers, and the fluid treatment characteristic of the permeable fluid treatment medium may comprise a removal rating of about 0.02 μm or coarser.

The ribbon, including the strip of permeable fluid treatment medium, may have a variety of lengths, thicknesses, and widths. For many embodiments, the ribbon may be continuous and extend the full length required to provide a sufficient number of windings to form a fluid treatment element having any desired radial dimension. For other embodiments, shorter segments of the ribbon may be connected end-to-end to extend the full length. Further, for many embodiments, the ribbon may be generally straight along the length of the strip. However, the ribbon may be curved. For example, the ribbon may have a cyclical, e.g., sinusoidal or sawtooth, pattern which extends along the length of the strip.

The thickness of the ribbon, including the strip of permeable fluid treatment medium, i.e., the distance through the ribbon from one major surface to the opposite major surface, may vary from one ribbon to another and/or from one fluid treatment element to another, depending, for example, on the structure of the porous fluid treatment medium. The thickness may be in the range from about two thousandths of an inch or less, for example, for a thin permeable polymeric membrane, to about 250 thousandths of an inch or more, for example, for a lofty fibrous material or a porous foam. Although the thickness may be nonuniform along the length of a ribbon, for many embodiments the thickness is uniform along the length of the ribbon.

The width of the ribbon, including the width of the strip of permeable fluid treatment medium, i.e., the maximum lateral distance through the ribbon from one side edge to the opposite side edge, may also vary from one ribbon to another and/or from one fluid treatment element to another. As fluid flows through the fluid treatment element 12, fluid may pass generally edgewise through the ribbon 20 and the strip of permeable fluid treatment medium 26 from one side edge 24, 24a; 25, 25a to the opposite side edge 25, 25a; 24, 24a. Consequently, the width of the ribbon may affect the pressure drop and the degree of treatment that the fluid undergoes. For example, the width of the ribbon may affect the filtration efficiency. For many embodiments, the width may be in the range from about one-sixteenth of an inch or less to about 1 inch or 2 inches or 3 inches or more. For example, the width may be in the range from about 2 inches or less, e.g., 1 inch or less, to about one-sixteenth inch or more, including the range from about one-eighth inch or more to about one-half inch or less. Further, the width may be generally uniform along the length of the ribbon, providing a more uniform treatment of the fluid as it flows through the fluid treatment element. Alternatively, the width of the ribbon may vary along the length, e.g., providing a fluid treatment element which tapers to a narrow rim or flares to a wide rim.

The ribbon 20 may include the strip of permeable fluid treatment medium 26 as the sole component of the ribbon, as shown in FIGS. 3A and 3B, and the major surfaces of the ribbon and the fluid treatment medium may be in contact along adjacent windings. Alternatively, the ribbon may include multiple components. For example, the ribbon 20 may include the permeable fluid treatment medium as one layer of a multilayer composite 30 with multiple layers arranged on top of one another, as shown in FIG. 3C. Various additional layers may be included, such as additional layers of permeable fluid treatment media 26a. The fluid treatment media 26, 26a may be identical to, or different from, one another. For example, the permeable fluid treatment medium layers may have the same fluid treatment characteristics or different fluid treatment characteristics, providing a fluid treatment element with fluid treatment media having different fluid treatment characteristics in parallel with one another. Another additional layer may be a strengthening strip 31 that enhances the structural integrity of the ribbon. The ribbon may be in tension as it is wound in multiple windings to form the fluid treatment element, and the strip of permeable fluid treatment medium may not have sufficient strength to withstand the tension. Consequently, a strengthening strip 31 that can withstand the tension, such as a strip of a polymeric film, may be layered with the fluid treatment medium. Another additional layer may be a bonding strip 32 for bonding adjacent surfaces of adjacent windings of the ribbon. The multiple layers of the composite ribbon may not all have of the same width or be in register. The ends of the layers may be in register or may be staggered. For many embodiments, the thickness of the additional layers, other than any additional fluid treatment medium layers, may be less than the thickness of the fluid treatment medium layers to increase the relative volume of the fluid treatment medium within the fluid treatment element. To reduce the amount of fluid that may bypass the fluid treatment medium as it flows through the fluid treatment element, the resistance to fluid flow edgewise through the additional layers may be at least substantially equal to or greater than the resistance to fluid flow edgewise through the fluid treatment medium layers. For some embodiments, the permeability edgewise through the additional layers may be at most substantially equal to or less than the permeability edgewise through the fluid treatment medium layers, and/or the removal rating edgewise through the additional layers may be substantially equal to or finer than the removal rating edgewise through the fluid treatment medium layers. For some embodiments some or all of the layers of the composite ribbon, other than the fluid treatment medium layers, may be impermeable. Alternatively, the resistance to fluid flow edgewise through the additional layers may be less than the resistance to fluid flow edgewise through the fluid treatment medium layers. For some embodiments, the permeability edgewise through the additional layers may be greater than the permeability edgewise through the fluid treatment medium layers, and/or the removal rating edgewise through the additional layers may be coarser than the removal rating edgewise through the fluid treatment medium layers.

Alternatively or additionally, the ribbon may include multiple components, e.g., two, three, four, five, or more components, that are arranged side-by-side in series in the fluid flow path edgewise through the ribbon. The side-by-side components may have spaces or intervening structures between them or may be arranged in close proximity, e.g., in contact. For example, multiple strips of fluid treatment media may be arranged edge side-by-edge side. The additional layer 26a of porous fluid treatment medium shown in FIG. 3C is but one example of a side-by-side arrangement of multiple strips. One strip 26a′ may be positioned coplanar with and in close proximity to an adjacent strip 26a″. For example, the side edges of the strips 26a′, 26a″ may contact one another along the length of the ribbon 20. The media may be similar to or different from another, e.g., may have the same or different fluid treatment characteristics. For some embodiments, two or more of the media may have different pore sizes, e.g., each successive medium may have a larger or smaller removal rating or pore structure, providing a pore size gradient across the width of the ribbon. For example, the downstream strip of fluid treatment medium may have a finer removal rating or pore structure than the upstream strip of fluid treatment medium. For other embodiments, two or more of the media may provide a different kind of fluid treatment, e.g., filtration, sorption, and ion exchange. The strips in the side-by-side arrangement may have similar or different widths, thicknesses, and/or lengths. The side-by-side strips may be supported in a variety of ways. For example, the multiple strips may be superposed with a support layer. The support layer may be thin and impermeable and may have a width which is less than, about equal to, or greater than the combined widths of the fluid treatment media strips.

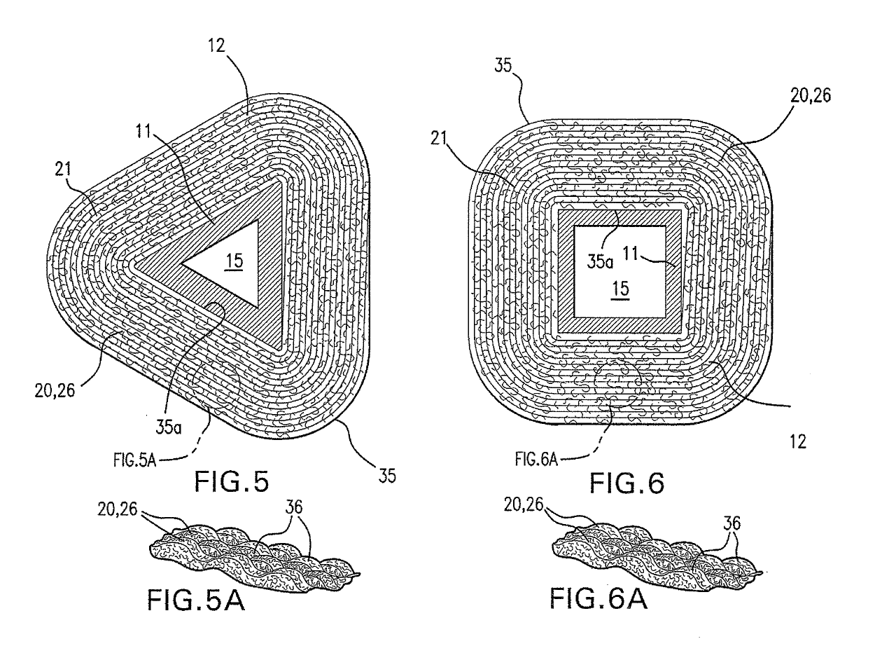

A fluid treatment element 12 formed by spirally winding the ribbon 20 in a plurality of windings may have any of numerous irregular or regular geometrical forms. For example, the spirally wound disk-shaped body 21, as well as the core assembly 11, of the fluid treatment element 12 may have a generally circular form, as shown in FIG. 2, or a generally oval, triangular, or rectangular form, as shown in FIGS. 4, 5, and 6, respectively. The radial dimension of a fluid treatment element 12, i.e., the dimension generally perpendicular to the axis of the core assembly 11, for example, from the innermost winding to the outermost winding, may vary, for example, in accordance with the number of windings and the thickness of the ribbon. For example, the radial dimension may be in the range from about ¼ inch or less or about ⅛ inch or less to up to about 1 inch or up to about 2 inches or up to about 6 inches or up to about 10 inches or up to about 25 inches or more. The volume of a fluid treatment element 12 may vary, for example, in accordance with the width of the ribbon and the radial dimension of the disk-shaped body. For some embodiments all of the fluid treatment elements of a fluid treatment arrangement may have the same volume. For some embodiments the fluid treatment elements of a fluid treatment arrangement may have different volumes.

As shown in FIG. 1, each disk-shaped body 21 may have one end surface, e.g., a feed or inflow surface 33, which generally faces in one axial direction, another end surface, e.g., a permeate or outflow surface 34, which generally faces in the opposite axial direction, an outer rim 35, and an inner rim 35a. One end surface comprises a plurality of windings of one side edge 24, 25 of the ribbon 20, including one side edge 24a, 25a of the fluid treatment medium 26. The other end surface comprises a plurality of windings of the other side edge 25, 24 of the ribbon 20, including the other side edge 25a, 24a of the fluid treatment medium 26. At least one of the end surfaces of at least one of the fluid treatment elements 12 includes a substantial portion, e.g., about 25% or more, or about 50% or more, or about 75% or more, which is an uneven surface. For many embodiments, the entire end surface may be uneven. FIGS. 2a, 4a, 5a, and 6a show a more detailed view of one example of an uneven surface. The inflow surface 33 may include an uneven surface and/or the outflow surface 34 may include an even surface. For many embodiments, at least one end surface, e.g., the inflow surface 33, of all fluid treatment elements 12 may be uneven and the opposite end surface, e.g., the cutflow surface 34, may be even.

An uneven surface may be structured in a wide variety of ways. For example, as shown in FIGS. 3A-3C, a substantial portion, including all, of at least one side edge 24, 25 of the ribbon 20, including at least one side edge 24a, 25a of the fluid treatment medium strip 26, may be pinked, i.e., may have a plurality laterally extending protrusions 36 which are spaced from one another along the side edge. Each protrusion may have any desired shape, including an irregular shape or a regular shape such as a scallop or a polygon, e.g., a rectangle or a triangle. The shape and spacing of the protrusions 36 may be uniform or nonuniform along the pinked side edge. Each protrusion 36 may extend longitudinally along the side edge 24, 25 of the ribbon 20 a distance that may, for example, be about 5% or less, or up to about 10%, or up to about 25%, or up to about 50%, or up to about 100% or more of the width of the ribbon 20. Each protrusion 36 may have a terminal end 37 and the terminal ends of the protrusions may extend laterally the same distance or different distances along the pinked side edge. The distance may be up to about 5%, or up to about 10%, or up to about 15%, or up to about 20%, or up to about 25% or more of the width of the ribbon 20 including the strip 26 of the fluid treatment medium.

An end surface of a disk-shaped body which is fashioned from a plurality of windings of a pinked side edge comprises an uneven surface which includes the protrusions extending axially away from the body. In FIGS. 3A and 3C, both side edges 24, 24a; 25, 25a of the ribbon 20, including the fluid treatment medium strip 26, may be pinked. Both end surfaces of a disk-shaped body formed by spirally winding the ribbon 20 may be uneven surfaces including protrusions respectively facing in opposite axial directions, as represented by the four fluid treatment elements 12 on the left of the fluid treatment arrangement 10 of FIG. 1. In FIG. 3B, only one side edge 24, 24a may be pinked, while the other side edge 25, 25a may be straight. A disk-shaped body formed by spirally winding the ribbon 20 in a plurality of windings may have an uneven end surface on one side of the body and an even end surface on the other side of the body, as represented by the four fluid treatment elements 12 on the right of the fluid treatment arrangement 10 of FIG. 1. The even end surface may include adjacent windings of the straight edge 25, 25a generally in register with one another, and the uneven end surface may include the protrusions 36 of the pinked side edge 24, 24a facing axially away from the body including the even end surface.

The protrusions may be arranged along a side edge of the ribbon in any of several ways. For example, the protrusions may be arranged along the ribbon such that a protrusion in one winding may directly overlie a corresponding protrusion in an adjacent winding, the protrusions registering with one another generally radially along the uneven end surface. The uneven end surface may then largely comprise the plurality of windings of the pinked side edge. The area of the uneven surface, e.g., the inflow surface and/or the outflow surface, may be about the same as the area of the spirally wound pinked side edge. A pinked side edge has a greater surface area than a straight side edge because the pinked side edge includes extended portions of the side edge that run along the protrusions. Consequently, the plurality of windings of the pinked side edge may form an uneven surface which has a larger surface area than an even end surface formed by a plurality of windings of a straight side edge.

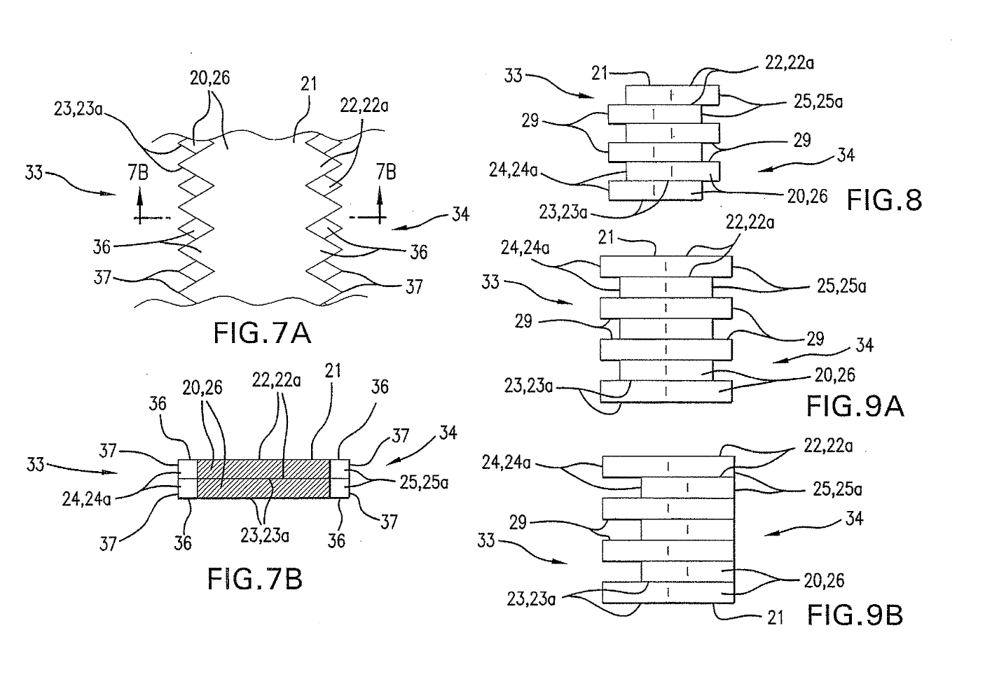

For many embodiments, the surface area of the uneven surface may be increased even further. The protrusions may be arranged along the ribbon such that a protrusion in one winding is circumferentially offset from a corresponding protrusion in an adjacent winding. Equal spacing between the protrusions along the side edge of the ribbon may provide such an offset. The amount of offset may be uniform or nonuniform along the adjacent windings. With the protrusions offset, a portion of one or both major surfaces of the ribbon, including a portion of one or both major surfaces of the fluid treatment medium strip, may be exposed at the uneven surface. The uneven end surface may then comprise not only the plurality of windings of the pinked side edge but also the exposed portions of the major surfaces. For example, in FIGS. 7A and 7B, part of a disk-shaped body 21 including two adjacent windings of the ribbon 20 of FIG. 3A is shown with the protrusions 36 of one winding circumferentially offset from the protrusions 36 of the adjacent winding. Portions of both major surfaces 22, 23; 22a, 23a of the ribbon 20, including the strip 26 of the permeable fluid treatment medium, are exposed, for example, at the protrusions 36 on both sides of the ribbon 20. Each uneven surface 33, 34 formed by the plurality of windings of the ribbon 20 includes the pinked side edge 24, 24a; 25, 25a and the exposed portions of the major surfaces 22, 23; 22a, 23a, and the area of each uneven surface 33, 34 comprises the area of the plurality of windings of the pinked side edge 24, 24a; 25, 25a and the area of the exposed portions of the major surfaces 22, 23; 22a, 23a.

An uneven surface may be structured in many other ways. For example, a ribbon, including a fluid treatment medium strip, which has a straight side edge may be spirally wound in a plurality of windings to form a disk-shaped body having an uneven surface which includes the plurality of windings of the straight side edge. In FIG. 8, part of a disk-shaped body 21 is shown with multiple windings of a ribbon 20. The ribbon 20, including the fluid treatment medium strip 26, may have straight side edges 24, 24a; 25, 25a on each side and a generally constant width along the length of the ribbon 20. The centerline of the ribbon 20 in one winding may be axially offset from the centerline of the ribbon 20 in an adjacent or nearby winding, axially overlapping the windings. The overlapped windings may form an uneven surface on both end surfaces 33, 34 of the disk-shaped body 21 and expose portions of the major surfaces 22, 22a; 23, 23a of the ribbon 20, including the fluid treatment medium strip 26, for example, at the overlapped regions 29 of the ribbon 20. Each uneven surface 33, 34 includes the straight side edges 24, 24a; 25, 25a and the exposed portions of the major surfaces 22, 23; 22a, 23a, and the area of each uneven surface includes the area of the plurality of windings of the straight side edges 24, 24a; 25, 25a and the area of the exposed portions of the major surfaces 22, 23; 22a, 23a.

In FIG. 9A part of another disk-shaped body 21 is shown with multiple windings of a ribbon 20. The ribbon 20 may have a varying width along the length of the ribbon. For example, the width may alternate between first and second widths, e.g., one winding having the first width and an adjacent or nearby winding having the second smaller width. The side edges 24, 24a; 25, 25a of the ribbon 20, including the fluid treatment medium strip 26, may be generally straight except at the transitions between the widths. The centerline of the ribbon 20 in one winding may be aligned with the centerline of the ribbon 20 in an adjacent or nearby winding, axially overlapping the windings at both end surfaces. The overlapped windings may then form an uneven surface on both end surfaces 33, 34 of the disk-shaped body 21 and expose portions of the major surfaces 22, 22a; 23, 23a of the ribbon 20, including the fluid treatment medium strip 26, for example, at the overlapped regions 29 of the ribbon 20. Alternatively, as shown in FIG. 9B, the centerline of the varying width ribbon 20, including the fluid treatment medium strip 26, in one winding may be axially offset from the centerline of the ribbon 20 in an adjacent or nearby winding, and one of the side edges 25, 25a may be in register from winding to winding, axially overlapping the windings at only one end surface, e.g., the inflow surface 33. The windings with the registered side edges 25, 25a may form an even surface 34, and the overlapped windings may then form an uneven surface 33 and expose portions of the major surfaces 22, 22a; 23, 23a, for example, at the overlapped regions 29 of the ribbon 20. In either embodiment, each uneven surface includes the side edges and the exposed portions of the major surfaces, and the area of the uneven surface includes the area of the plurality of windings of the side edge and the area of the exposed portions of the major surfaces.

The fluid treatment elements may be positioned along the core assembly 11 with adjacent elements spaced from one another or in close proximity to, e.g., contacting, one another along an interface. Further, adjacent fluid treatment elements may be structurally separate from one another. For many embodiments, the inflow surfaces 33 of some adjacent fluid treatment elements 12 may face one another and define a feed space 13 between them, and the outflow surfaces 34 of some adjacent elements 12 may face one another and define a permeate space 14 between them. In the embodiment shown in FIG. 1, the permeate spaces 14 may fluidly communicate with the interior 15 of the core assembly 11 via openings 16 in the core assembly 11, and the feed spaces 13 may be fluidly isolated from the interior of the core assembly 11 by a solid wall portion of the core assembly. The distance between adjacent fluid treatment elements may define the width of each space 13, 14, and the widths of the spaces 13, 14 may be uniform or non-uniform. For example, the distances between adjacent inflow surfaces 33 and the widths of the feed spaces 13, as well as the distances between adjacent outflow surfaces 34 and the widths of the permeate spaces 14, may be substantially equal to, or different from, one another. Further, the distances between adjacent inflow surfaces 33 and the widths of the feed spaces 13 may be substantially equal to, or different from, the distances between adjacent outflow surfaces 34 and the widths of the permeate spaces 14.

The spaces 13, 14 may extend between adjacent fluid treatment elements 12 along at least about 85%, or at least about 90%, or at least about 95%, or about 100% of the radial dimension of the fluid treatment elements 12. For example, the spaces 13, 14 may extend at least about 85%, or at least about 90%, or at least about 95%, or about 100% of the distance from the core assembly to the outer rims 35 at the exterior of the elements. Further, many or all of the spaces 13, 14 may be substantially free of structure, for example, as disclosed in U.S. Provisional Application No. 60/907,068 entitled Fluid Treatment Elements and Fluid Treatment Arrangements with Spaces Between Fluid Treatment Elements and Methods for Making and Using Them, which listed Thomas Welch, Jr., Tanweer ul Hag, and Joseph Verschneider as an inventor and which was filed on Mar. 19, 2007, and the PCT International Application which claims priority based on this Provisional Application, both of which are incorporated by reference to support these and other features. Alternatively, some or all of the spaces may include, for example, may be occupied by, any of a variety of structures, including structures which may serve as spacers and/or supports. These structures may include rigid or flexible plates or grids that may have channels, ribs and/or openings to guide fluid through the spaces. Alternatively, these structures may include one or more layers of mesh or a mass of coarse fibers through which fluid may flow into or out of the spaces. As yet another alternative, these structures may include one or more posts that extend within the spaces, for example, as disclosed in U.S. Provisional Application No. 60/907,078 entitled Fluid Treatment Arrangements with Posts and/or Bands Between Fluid Treatment Elements and Methods for Making Them, which listed Thomas Welch Jr., Stephen Geibel, and Tanweer ul Haq as an inventor, which was filed on Mar. 19, 2007, and the PCT International Application which claims priority based on this Provisional Application, both of which are incorporated by reference to support these and other features.

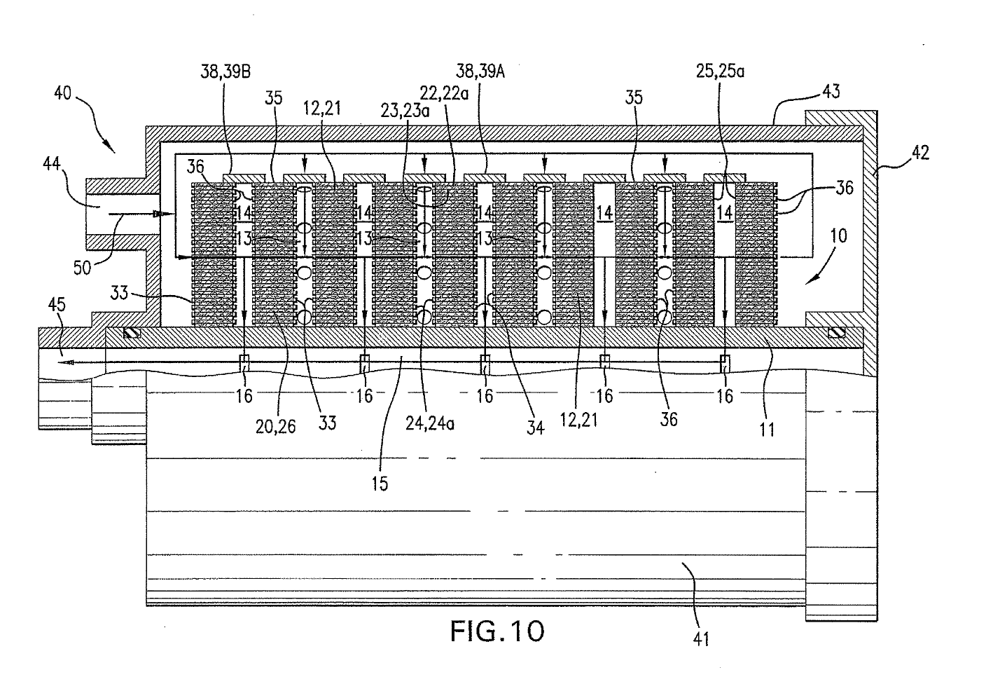

The fluid treatment arrangement may further include additional components, including, for example, a surround associated with the spaces between spaced fluid treatment elements and/or the interfaces between proximal or contacting fluid treatment elements to fluidly isolate one or more of the spaces and/or interfaces, for example, from the exterior of the fluid treatment elements. The surround may be configured in a wide variety of ways, including, for example, as one or more components separate from but associated with the fluid treatment elements. One of many different examples of a surround 38 is shown in FIG. 10. The fluid treatment elements 12 and the core assembly 11 shown in FIG. 10 may be identical to those previously described, but neither the surround, the fluid treatment elements, nor the core assembly are limited to the features shown in FIG. 10. The illustrated surround 38 comprises a plurality of axially spaced bands 39A encircling the feed spaces 13, bridging the outer rims 35 of the disk-shaped bodies 21 of the adjacent fluid treatment elements 12, and having openings that fluidly communicate between the feed spaces 13 and the exterior of the fluid treatment elements 12. The surround 38 may further comprise a plurality of axially spaced bands 39B encircling the permeate spaces 14 and bridging the outer rims 35 of the fluid treatment elements 12 adjacent to each permeate space 14. For many embodiments, the bands 39 may span the spaces 13, 14 but may be arranged to leave at least a portion of the outer rims 35 of adjacent fluid treatment elements 12 exposed. For other embodiments the bands may span the spaces and completely cover the outer rims of one or both adjacent fluid treatment elements or may span the spaces but not extend along the outer rims of adjacent fluid treatment elements.

Alternatively, the surround may have any configuration that fluidly blocks the outer ends of at least some of the spaces, e.g., the permeate spaces, the interfaces, and the outer rims of the second fluid treatment elements and allows fluid communication with other spaces, e.g., the feed spaces. For example, the surround may comprise a sleeve that encircles all of the spaces, interfaces, and the fluid treatment elements, or a helical wrap that is wrapped around all the spaces, the interfaces, and the outer rims of the second fluid treatment elements and the fluid treatment elements, fluidly blocking the outer ends of some of the spaces and having openings that allow fluid communication at the outer ends of other spaces, e.g., fluid communication between the outer rims and the exterior of the fluid treatment elements and other spaces.

The surround may be sealed to the fluid treatment elements in a variety of ways. For many embodiments, the surround 38 may be impermeable and may be bonded to the disk-shaped bodies 21 of the fluid treatment elements 12. For example, the bands 39 may comprise impermeable strips, e.g., impermeable polymeric strips, and may be adhesively bonded, solvent bonded, or heat bonded to the outer rims 35 of the fluid treatment elements 12. Alternatively, the bands may comprise a settable material such as a hot-melt adhesive, a polyurethane, or an epoxy, for example, as disclosed in the previously referenced U.S. Provisional Application No. 60/907,078 entitled Fluid Treatment Arrangements with Posts and/or Bands Between Fluid Treatment Elements and Methods for Making Them and the PCT International Application which claims priority based on this Provisional Application.

Fluid treatment arrangements and elements may be made in any of several different ways. For example, methods of making a fluid treatment element may comprise spirally winding a ribbon having a permeable fluid treatment medium in a plurality of windings to form a disk-shaped body having first and second opposite end surfaces and an outer rim. Spirally winding the ribbon includes forming at least one of the first and second end surfaces to include an uneven surface.

Methods of making a fluid treatment arrangement may, for example, comprise forming a plurality of fluid treatment elements by spirally winding a plurality of ribbons in a plurality of windings to form disk-shaped bodies. Each ribbon may have a permeable fluid treatment medium, and each disk-shaped body may have first and second opposite end surfaces and an outer rim. Forming the plurality of fluid treatment elements includes forming at least one end surface of at least one fluid treatment element to include an uneven surface. Methods of making a fluid treatment arrangement may further comprise axially positioning the fluid treatment elements along a hollow core assembly.

The fluid treatment elements may be positioned along the core assembly in a variety of ways. For example, at least two and as many as at least 10 or more, or at least 25 or more, or at least 50 or more or at least 100 or more ribbons may be spirally wound in a plurality of windings around the core assembly to form fluid treatment elements at different axial locations along the core assembly. All of the fluid treatment elements may be located along the core assembly to provide spaces between them. Alternatively, some adjacent fluid treatment elements may be located along the core assembly in close proximity, e.g., in contact, side-by-side, while other fluid treatment elements may be located along the core assembly to provide spaces between adjacent fluid treatment elements. All of the fluid treatment elements may have identical or similar treatment characteristics. Alternatively, the fluid treatment elements may have different treatment characteristics, for example, as disclosed in U.S. Provisional Application No. 60/907,069 entitled Fluid Treatment Arrangements with Fluid Treatment Elements Having Different Fluid Treatment Characteristics and Methods for Making Them, which listed Thomas Welch, Jr., Mark Hurwitz, Tanweer ul Hag, Joseph Verschneider as an inventor and which was filed on Mar. 19, 2007, and the PCT International Application which claims priority based on this Provisional Application, both of which are incorporated by reference to support these and other features.

The ribbons may be wound around the core assembly one at a time, several at a time, or all at the same time, e.g., either sequentially or simultaneously. The inner end region of the ribbon, e.g., the region defining the first one, two, or three windings, may be sufficiently sealed against the core assembly to prevent bypass of the fluid treatment element. For example, the inner end region may be fixed to the core assembly by heat bonding, adhesively bonding, or solvent bonding the inner end region to the core assembly. Alternatively, the inner end region may not be bonded to the core assembly but may, for example, be compressively fit against the core assembly by tightly winding the initial windings around the core assembly. Further, the inner end region may have a tapered thickness or may be sufficiently tightly wound that no step is formed at the transition between the end of the first winding and the beginning of the second winding.

Any or all of the ribbons may be spirally wound to form at least one uneven end surface on the disk-shaped body. For many embodiments, both end surfaces of the disk-shaped body may be formed as an uneven surface. For example, a ribbon having one or two pinked side edges may be spirally wound in a plurality of windings forming one or two uneven end surfaces which comprises a plurality of axially extending protrusions. Alternatively, a ribbon having one or two straight side edges may be spirally wound in a plurality of windings, and some of the windings may be axially overlapped beyond other windings forming at least one uneven end surface. For example, the ribbon may be spirally wound with the centerline of the ribbon axially offset from one winding to another winding, overlapping the offset windings. Spirally winding the ribbon may include overlapping adjacent windings or overlapping any other arrangement of windings, e.g., every third winding or adjacent pairs of windings. For many embodiments, spirally winding the ribbon further includes exposing a portion of one or both major surfaces of the ribbon, including the fluid treatment medium strip, along the uneven surface in addition to the side edge of the ribbon. For example, portions of the axially extending protrusions or the axially extending overlapped regions of the ribbon may be exposed.

Each ribbon may be spirally wound in a plurality of windings under tension to form a fluid treatment element of any desired radial dimension. The tension may be constant or may vary with increasing radius of the fluid treatment element, and the tension may be empirically selected based on many factors. For example, a maximum tension at which the ribbon detrimentally elongates, e.g., the tension at which the fluid treatment medium unduely stretches or begins pulling apart, may be determined. The ribbon may then be spirally wound using a tension less than the maximum tension, for example, no greater than about 80% or no greater than about 65% or no greater than about 50% of this maximum tension. Further, the ribbon may be spirally wound using a tension which provides similar compression, e.g., substantially uniform compression, of the fluid treatment medium from one winding to the next along most or all of the radial dimension of the fluid treatment element. By providing similar compression from one winding to the next, the fluid treatment element may more evenly treat the fluid flowing edgewise through the plurality of windings of the fluid treatment medium. For example, if the fluid treatment medium comprises a filter medium, the fluid treatment element may be more uniformly loaded along the radial dimension of the element, increasing the dirt capacity and/or the service life of the element. In addition, the ribbon may be spirally wound with sufficient tension to inhibit or prevent the flow of fluid laterally between adjacent surfaces of adjacent windings and adjacent layers of the ribbon. For example, the ribbon may be spirally wound with sufficient tension that substantially no fluid laterally passes between the adjacent surfaces and adjacent layers or with sufficient tension that any fluid pathway laterally between the adjacent surfaces and adjacent layers of the ribbon has a permeability and/or a removal rating which is not substantially greater or coarser than the permeability and/or removal rating of the fluid pathway edgewise through the fluid treatment medium. The ribbon may also be wound with sufficient tension to form a substantially self-supporting fluid treatment element having a stable, firm disk-shaped body. For example, the ribbon may be wound with sufficient tension to hold adjacent windings and adjacent layers against each other tightly enough to prevent lateral slippage and/or radial separation of the adjacent windings and adjacent layers at the differential pressures encountered by the fluid treatment element.

After each ribbon has been spirally wound to a desired radial dimension, the outer end region of the ribbon may be held in place in any of numerous ways. For example, the outer end region may be bonded to the adjacent winding for example, by heat bonding, adhesive bonding, or solvent bonding. Alternatively or additionally, the outer end region of the ribbon may be staked to other windings. For example, a hot, metal pin may be inserted generally radially through the outer end region of the ribbon and the outer windings, melting the portions of the ribbon that contact the pin. When the pin is withdrawn, the molten portions solidify with one another, forming a generally radial stake which holds the outer end region, including any multiple layers of the ribbon, and the outer windings in place. Alternatively or additionally, a hollow needle, which may or may not be hot, may be inserted generally radially through the outer end region and the outer windings or in the space between adjacent windings. A liquid settable bonding composition or material, including, for example, a polyurethane, an epoxy, or a hot melt adhesive, may be injected into the windings as the needle is withdrawn, forming a generally radial stake which holds the outer end region and the windings in place. As yet another alternative, a stake, for example, in the form of a weld bead or a bead of settable bonding material, may be drawn along one or both side edges of the outer end region of the ribbon and the outer windings.

The stability of a spirally wound fluid treatment element may be further enhanced by staking much or all of the disk-shaped body. For example, generally radially extending stakes may be formed through most or substantially all of the windings and/or at various angularly-spaced positions around the disk-shaped body. Similarly, stakes may be applied along one or both end surfaces of the fluid treatment element and/or at various angularly-spaced positions around each surface, including the surfaces at the interface between the first and second fluid treatment elements. Each stake may extend mostly or completely through or along the fluid treatment element, e.g., to the core assembly, fixing the fluid treatment to the core assembly.

The stability of a spirally wound fluid treatment element may also be enhanced by bonding adjacent windings, and/or adjacent layers of the ribbon, to one another continuously or intermittently along the length of the spirally wound ribbon. Adjacent windings and/or layers may be bonded in a variety of ways. For example, the ribbon may include a bonding layer, as previously described. The bonding layer may comprise an adhesive which bonds adjacent windings and/or layers as the ribbon is spirally wound. Alternatively, the bonding layer may be activated by applying a solvent or heat to the fluid treatment element after the element is formed. As yet another alternative, a hot melt adhesive or a heat bond may be applied, for example, intermittently, between adjacent windings and/or layers as the ribbon is spirally wound.

The fluid treatment elements may be positioned along the core assembly with spaces between some, many or all of the elements. Some of the spaces, e.g., the feed spaces 13, may be positioned in fluid communication with the exterior of the fluid treatment arrangement and some of the spaces, e.g., the permeate spaces 14, may be fluidly isolated from the exterior of the fluid treatment arrangement. Further, some of the spaces e.g., the permeate spaces 14, may be positioned in fluid communication with the openings in the core assembly and other spaces, e.g., the feed spaces 13, may be fluidly isolated from the interior of the core assembly. Before, while, or after the fluid treatment elements are positioned along the core assembly, various structures may be arranged along the core assembly in, or at the locations corresponding to, some or all of the spaces between the elements. For example, meshes, fibrous masses, plates, grids, and/or posts may be positioned in some or all of the spaces between the elements.

The surround may be coupled to the fluid treatment elements, the interfaces, and the spaces in a variety of ways. For example, a surround comprising a plurality of bands may be positioned around the interfaces and spaces, and the bands may be sealed to the adjacent fluid treatment elements, e.g., at the outer rims. Alternatively, a surround comprising a sheet spanning the fluid treatment elements, the interfaces, and spaces may be wrapped circumferentially around the elements, the interfaces, and spaces and formed into a sleeve, or a surround comprising a preformed sleeve may be slid axially over the fluid treatment elements, the interfaces, and spaces. The sleeve may be sealed to the fluid treatment elements, e.g., at the outer rims. Openings may be formed in the sleeve which allows the spaces that are fluidly isolated from the core assembly to fluidly communicate with the exterior of the fluid treatment elements. As yet another alternative, a surround comprising a wide strip may be helically wound around the fluid treatment elements and the spaces with adjacent helical windings overlapping one another. The wrap may be sealed to the fluid treatment elements, and openings may be formed in the wrap which allows the spaces that are fluidly isolated from the core assembly to fluidly communicate with the exterior of the fluid treatment elements.

After the fluid treatment arrangements are formed, they may be contained within a wide variety of housings to provide fluid treatment assemblies. The fluid treatment assembly may comprise a housing containing only a single fluid treatment arrangement or a housing containing multiple fluid treatment arrangements arranged serially or in parallel within the housing. For example, the housing may include one or more tube sheets and multiple fluid treatment arrangements may be associated with the tube sheets. The housing may permanently contain the fluid treatment arrangement, e.g., forming a disposable fluid treatment arrangement, or the housing may removably contain the fluid treatment arrangement, allowing a used fluid treatment arrangement to be replaced by a new fluid treatment arrangement in a reusable housing.

The housing may be formed from any impermeable material, e.g., a metallic material or a polymeric material, which is compatible with the process parameters, e.g., the pressure and temperature and the chemical composition of the fluid. The housing may have two or more principle ports, e.g., a process or feed fluid inlet port and a filtrate or permeate outlet port. The housing may define a fluid flow path between the ports, and the fluid treatment arrangement may be positioned in the housing with the first and second fluid treatment elements disposed in series in the fluid flow path. The ports may be situated on the housing in any of numerous configurations, including an in-line configuration, a T-type configuration, or an L-type configuration, and the ports may comprise any of a wide variety of fittings. The housing may further include additional ports, including, for example, a retentate or concentrate outlet port and one or more ports associated with draining, venting, or cleaning, e.g., backwashing.

One of many examples of a fluid treatment assembly 40 and a housing 41 containing at least one fluid treatment arrangement 10 is shown in FIG. 10, but fluid treatment assemblies and housings are not limited to the features illustrated in FIG. 10. The housing 41 may include a cover 42 and a shell 43. The cover 42 may be permanently or removably mounted to the shell 43 at one end of the shell 43. The other end of the shell 43 may have a feed inlet port 44 and a permeate outlet port 45. The illustrated embodiment of the fluid treatment assembly 40 has only two ports 44, 45, and they are located on one end of the housing 41. Other embodiments may include more than two ports, and the ports may be located anywhere along the housing, e.g., at both ends and/or in the side of the housing.

The fluid treatment arrangement 10 may be sealed within the housing 41 across a fluid flow path 50 between the feed inlet port 44 and the permeate outlet port 45 with the shell 43 surrounding the fluid treatment elements 12. A portion of the fluid flow path 50 between the inlet port 44 and the outlet port 45 includes the fluid flow pathways which extend generally edgewise through the fluid treatment media of the fluid treatment elements 12. At least one end surface of at least one fluid treatment element may include an uneven surface. For many embodiments, at least one end surface, e.g., the inflow surface 33 or both the inflow surface 33 and the outflow surface 34, of each fluid treatment element 12 may be an uneven surface. The fluid flow path 50 then extends between the inlet port 44 and the outlet port 45 through at least one uneven surface, e.g., an uneven inflow surface 33. The fluid treatment arrangement 10 may be sealed in the housing 41 in any of numerous ways. For example, one end of the hollow core assembly 11 may be blindly sealed against the cover 42. The opposite end of the hollow core assembly 11 may be open and sealed to the shell 43 at the permeate outlet port 45, allowing fluid communication between the interior 15 of the core assembly 11 and the permeate outlet port 45. For many embodiments, none of the fluid treatment elements may be sealed to the housing 41. For example, only the core assembly 11 may be sealed to the housing 41, minimizing seals and providing a highly reliable fluid treatment assembly.

Fluids may be treated in a wide variety of ways by fluid treatment assemblies, arrangements, and elements embodying the invention. In one mode of operation, a feed fluid may be treated by passing fluid through at least one fluid treatment element including a disk-shaped body from a first end surface on one side of the body to a second end surface on the opposite side of the body. At least one of the first and second end surfaces may be an uneven surface, and passing the fluid through the fluid treatment element includes directing the fluid into and/or out of the uneven surface. Passing the fluid through the fluid treatment element further includes passing the fluid generally edgewise through a permeable fluid treatment medium of a ribbon spirally wound in a plurality of windings to form the disk-shaped body.

For example, the feed fluid may be directed through the fluid treatment assembly 40 along the fluid flow path 50, where the fluid is treated by the fluid treatment elements 12. The feed fluid may be directed inside-out through the fluid treatment arrangement from the interior of the core assembly to the exterior of the fluid treatment elements. However, in the illustrated fluid treatment assembly 40, the feed fluid may be directed outside-in through the fluid treatment arrangement 10 from the exterior of the fluid treatment elements 12 to the interior 15 of the core assembly 11. The feed fluid may enter the housing 41 through the feed inlet port 44 and follow the fluid flow path 50 to the permeate outlet port 45. From the feed inlet port 44, the feed fluid may flow generally axially along the housing 41 between the exterior of the disk-shaped bodies 21 of the fluid treatment elements 12 and the interior of the shell 43. The feed fluid then flows generally radially inwardly into the feed spaces 13 between the feed surfaces 33 of the fluid treatment elements 12 and along any structures which may be in the feed spaces.

From the feed spaces 13, the feed fluid may flow generally axially through each adjacent fluid element 12. For example, the feed fluid may flow generally axially into the inflow surface 33 on one end of the disk-shaped body 21 of each fluid treatment element 12 and generally edgewise through the ribbon 20, including the fluid treatment medium 26, of each winding. The fluid may also flow from the fluid treatment medium 26 of one winding radially into and then laterally along the medium of one or more adjacent or nearby windings. As the fluid passes through the fluid treatment medium 26, the fluid is treated in accordance with the fluid treatment characteristic of the medium. From the fluid treatment medium 26, the fluid may flow out of the fluid treatment element 12 through the outflow surface 34 on the other end of the disk-shaped body 21. At least one, and for many embodiments both, of the end surfaces 33, 34 of the disk-shaped body 21 may be an uneven surface. Passing the fluid through the fluid treatment element 12 may then include directing fluid into an uneven inflow surface 33 and/or out of an uneven outflow surface 34. For example, the fluid may be directed into and/or out of a plurality of axially extending protrusions 36 or axially overlapped windings or axially offset windings along an uneven inflow surface 33 and/or an uneven outflow surface 34. Further, directing fluid into and/or out of an uneven surface includes passing fluid into and/or out of a plurality of windings of a side edge 24, 24a; 25, 25a of the ribbon 20, including the fluid treatment medium strip 26. For many embodiments, directing fluid into and/or out of an uneven surface also includes passing fluid into and/or out of exposed portions of the first and second major surfaces 22, 22a; 23, 23a of the ribbon 20, including the fluid treatment medium strip 26. For example, the fluid may enter the ribbon 20 through the exposed portions of the major surface 22, 22a; 23, 23a generally radially and then flow generally laterally through the ribbon 20, e.g., generally edgewise through the fluid treatment medium 26.

The treated fluid emerges from the outflow surfaces 34 of the fluid treatment elements 12 and flows into the permeate spaces 14 between the outflow surfaces 34. From the permeate spaces 14, the treated fluid may flow generally radially inwardly through the openings 16 into the interior 15 of the core assembly 11. The treated fluid then flows axially along the interior 15 of the core assembly 11 to and through the permeate outlet port 45 of the housing 41.

Many advantages are associated with fluid treatment assemblies, arrangements, and elements embodying one or more aspects of the invention. In particular, by providing one or more fluid treatment elements having one or two uneven end surfaces, the fluid may be treated much more efficiently. For example, fluid treatment elements having an uneven inflow surface may have a particularly high dirt capacity. The surface area of an uneven end surface can be much higher than the surface area of an even end surface, as previously described. A fluid treatment element having an uneven inflow surface can thus have a dirt capacity that is up to about 25% or more or up to about 50% or more of a fluid treatment element having an even inflow surface. A greater dirt capacity may result in a longer service life, less down time for replacement, and less environmental waste due to fewer changeouts.

Further, fluid treatment elements having an uneven inflow surface and/or an uneven outflow surface may enhance fluid flow to and/or from the end surfaces of the elements, especially when the elements are in close proximity to one another. An uneven surface has channels that more evenly distribute fluid over the entire inflow surface and/or drain fluid from the entire outflow surface. By more evenly distributing and draining fluid over the end surfaces of the fluid treatment elements, preferential fouling may be reduced and more of the fluid treatment medium may be effectively utilized to treat the fluid.

In addition, spirally winding separate ribbons to separately form each of the plurality of fluid treatment elements facilitates manufacturing different configurations of fluid treatment arrangements and elements. The radial dimension of each element may be easily varied by winding more or less of the ribbon around the core assembly; the number of fluid treatment elements provided along the core assembly can be easily varied by winding more or fewer ribbons around the core assembly; and the location of the fluid treatment elements along the core assembly can be easily varied by simply adjusting the spacing between the ribbons being wound around the core assembly. Further, the ribbons may be spirally wound around the core assembly very quickly, speeding manufacture. Using a plurality of separate, narrow ribbons instead of, for example, a single, wide sheet with slots or other through holes in the sheet may then significantly enhance the flexibility and efficiency of manufacture, allowing fluid treatment arrangements with various numbers of elements and spacings between elements to be made without having to change out sheets of different widths or different through hole configurations. In addition, if a defect such as a hole or tear in the permeable fluid treatment medium occurs during manufacture, only the defective ribbon may be replaced rather than an entire sheet, allowing for faster and more efficient production.

While various aspects of the invention have been previously described and/or illustrated with respect to several embodiments, the invention is not limited to these embodiments. For instance, one or more features of these embodiments may be eliminated without departing from the scope of the invention. For example, as previously described, the surround 38 may include one or more bands 39A that encircle the feed spaces 13 and have openings that fluidly communicate between the exterior of the fluid treatment elements 12 and the feed spaces 13. These bands 39A may be entirely eliminated without departing from the scope of the invention. The feed spaces may simply open onto the exterior of the fluid treatment elements.

Further, one or more features of an embodiment may be modified, or one or more features of any embodiment may be combined with one or more features of other embodiments, without departing from the scope of the invention. For example, the embodiments of the disk-shaped bodies 21 shown in FIGS. 8, 9A and 9B may be formed from a ribbon having one or two pinked side edges 24, 24a; 25, 25a as shown in FIGS. 3A-3C. The resulting fluid treatment element may then have one or two uneven end surfaces which include both the overlapping windings of the embodiments shown in FIGS. 8, 9A and 9B and the protrusions 36 of the embodiment shown in FIGS. 7A and 7B.

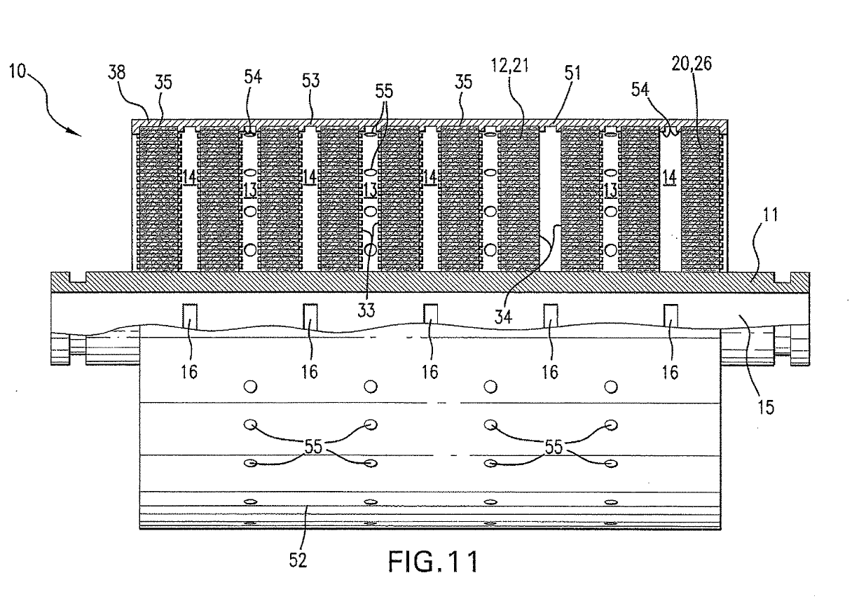

As another example, the surround may comprise a more rigid structure to provide additional support at the outer rims of the fluid treatment elements. In one embodiment, the surround 38 may comprise semi-cylindrical sections 51, 52 which may be joined to form a more rigid cage 53, as shown in FIG. 11. The fluid treatment elements 12 and the core assembly 11 shown in FIG. 11 may be identical to those previously described, but neither the surround, the fluid treatment elements, nor the core assembly are limited to the features shown in FIG. 11. Each fluid treatment element 12 may comprise a spirally wound ribbon 20 having a strip of a fluid treatment medium 26. One or more of the fluid treatment elements 12 may include one or two uneven end surfaces 33, 34. The sections 51, 52 of the surround 38 may be fitted around the outer rims 35 of the disk-shaped bodies 21 of the fluid treatment elements 12 and permanently or removably joined to one another to form the cage 53. The outer rims 35 of the disk shaped bodies 21 of the fluid treatment elements 12 may be sealed against the cage 53 in a variety of ways. For example, the outer rims 35 may be adhesively bonded or heat bonded to the cage 53. Alternatively or additionally, the outer rims 35 may be sealed against the cage 53 by a tight mechanical fit. For example, a pair of circumferential ribs 54 may extend inwardly a short distance from each section 51, 52 and may be spaced apart a distance equal to or slightly less than the width of the outer rim 35 of each fluid treatment element 12. The sections 51, 52 may be fitted around the fluid treatment arrangement 10 with each outer rim 35 fitting between a corresponding pair of ribs 54. The cage 53 may include openings 55 that allow some of the spaces, e.g., the feed spaces 13, to fluidly communicate with the exterior of the fluid treatment elements 12. The cage 53 may fluidly isolate other spaces, e.g., the permeate spaces 14, from the exterior of the fluid treatment elements 12

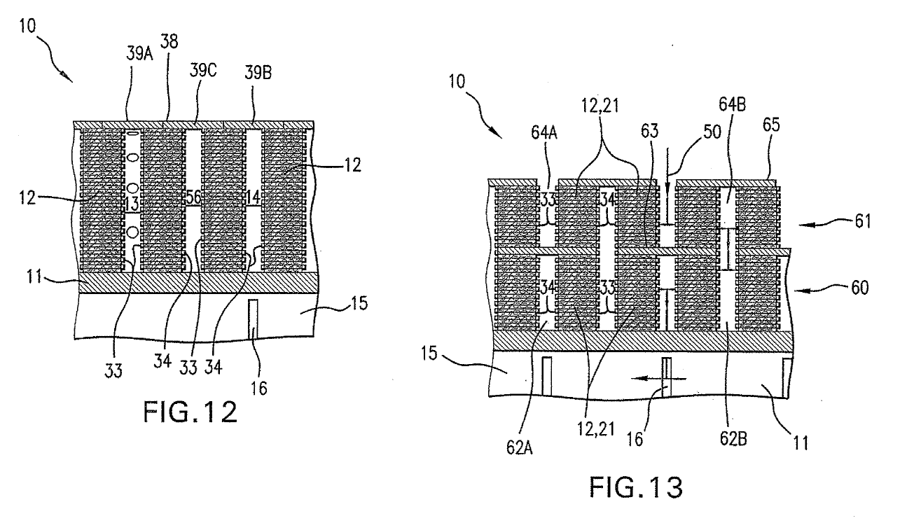

As another example, some of the spaces between adjacent fluid treatment elements may be arranged to be fluidly isolated from both the interior of the core assembly and the exterior of the fluid treatment elements. A portion of a fluid treatment arrangement 10 including fluid elements 12 and a core assembly 11 is shown in FIG. 12. The fluid treatment elements 12 and the core assembly 11 illustrated in FIG. 12 may be identical to those previously described, but neither the fluid treatment arrangement, the fluid treatment elements, the core assembly, nor the surround are limited to the features shown in FIG. 12. The fluid treatment arrangement 10 may include at least one intermediate or intervening space 56 positioned between a feed space 13 and a permeate space 14. The intermediate space 56 may face an outflow surface 34 of one adjacent fluid treatment element 12 and in inflow surface 33 of the other adjacent fluid treatment element 12, and either or both surfaces 34, 33 may be an uneven surface. The intermediate space 56 may be fluidly isolated from the interior 15 of the core assembly 11 by a solid wall portion of the core assembly 11 and may be fluidly isolated from the exterior of the fluid treatment elements 12 by the surround 38. In addition to a band 39A having openings encircling the feed spaces 13 and a band 39B encircling the permeate spaces 14, the surround 38 may include a band 39C such as an impermeable, imperforate band, which encircles the intermediate space 56 and is sealed to the outer rims 35 of the adjacent fluid treatment elements 12. Each band 39A, 39B, 39C may abut an adjacent band. The intermediate space 56 may or may not be substantially free of structure. For example, the intermediate space may be filled with particles of a functional material such as a sorbent or an ion exchange resin. Fluid may flow generally radially into a feed space 13; generally axially through one fluid treatment element 12, the intermediate space 56, and an adjacent fluid treatment element 12 to a permeate space 14; and then generally radially out of the permeate space 14 through the opening 16 into the interior 15 of the core assembly 11.

As yet another example, fluid treatment elements may be positioned along the core assembly by sliding preformed elements generally axially along the core assembly. For example, ribbons may be spirally wound in a plurality of windings to a desired radial dimension around separate central hubs, rather than around the core assembly, to form a fluid treatment element. Some or all of the fluid treatment elements may include one or two uneven end surfaces, as previously described. The preformed fluid treatment elements may then be slid axially, with or without the hubs, along the core assembly to the desired locations and fixed in place.

Further, embodiments having different features may nonetheless be within the scope of the invention. For example, ribbons may be spirally wound around separate hubs to form the fluid treatment elements. Some or all of the fluid treatment elements may include one or two uneven end surfaces, as previously described. Each hub may comprise a section of the core assembly, and the hub sections of adjacent elements may be connected to one another to form the hollow core assembly and the fluid treatment arrangement. The hub sections may be mechanically coupled to one another and/or bonded to one another, and some of the hub sections may include openings which allow fluid communication with the interior of the core assembly.

As yet another example, a fluid treatment arrangement may include multiple sets, e.g., two, three, four or more sets, of fluid treatment elements which are mounted along a core assembly radially displaced from one another, for example, in a manner similar to that disclosed in U.S. Provisional Application No. 60/907,066 entitled Fluid Treatment Arrangements with Sets of Fluid Treatment Elements and Methods for Making and Using Them and which listed Thomas Welch, Jr., Tanweer ul Haq, and Joseph Verschneider as an inventor and which was filed on Mar. 19, 2007, and the PCT International Application which claims priority based on this Provisional Application, both of which are incorporated by reference to support these and other features. Each set may include a plurality of fluid treatment elements, each element including a ribbon which is spirally wound in a plurality of windings to form a generally disk-shaped body having a radial dimension. One or more of the fluid treatment elements of any set may include one or two uneven end surfaces, as previously described. Further, the fluid treatment elements of the multiple sets may have the same or different fluid treatment characteristics. The outer set of fluid treatment elements may overlie the inner set of fluid treatment elements with the elements of the inner and outer sets radially and/or axially aligned or offset. For example, the elements of the outer set may bridge at least some of the spaces between the elements of the inner set. Further, the size, e.g., the width and radial dimension, and/or the volume of the outer set of fluid treatment elements may be the same as or different from those of the inner set of fluid treatment elements.

In the embodiment shown in FIG. 13, a fluid treatment arrangement 10 may include at least inner and outer sets 60, 61 of fluid treatment elements 12 having disk-shaped bodies 21 mounted along a core assembly 11. The inner set 60 of second fluid treatment elements 12 may be positioned along and immediately circumjacent to the core assembly 11 as previously described, with spaces 62 between at least some or all of the adjacent inner fluid treatment elements 12. An inner surround comprising, for example, a plurality of inner bands 63, may bridge some of the inner spaces 62 between adjacent inner fluid treatment elements 12. The features of the core assembly 11, the fluid treatment elements 12 of the inner set 60, the inner spaces 62 and the inner bands 63 may be similar to those previously described. In particular, at least one, and for many embodiments most or all, of the fluid treatment elements 12 of the inner set 60 may have an uneven inflow surface 33 and/or an uneven outflow surface 34. Radially displaced from the inner set 60 of fluid treatment elements 12, the outer set 61 of fluid treatment elements 12 may be positioned along the core assembly 11 with spaces 64 between at least some or all of the outer fluid treatment elements 12. The outer fluid treatment elements 12 may be spirally wound around the inner fluid treatment elements 12 and/or the inner surround, e.g., the inner bands 63. The inner end region of the ribbon of each outer fluid treatment element 12 may be sealed against the inner fluid treatment elements 12 or the inner bands 63 as previously described for the inner end region of the ribbon of each fluid treatment element 12 and the core assembly 11 of the embodiment of FIG. 1. The size and/or volume of each outer fluid treatment element 12 may be the same as or different from the size and/or volume of each inner fluid treatment element 12. The fluid treatment characteristics of the outer and inner fluid treatment 12 may be the same or different. An outer surround comprising, for example, a plurality of outer bands 65, may bridge at least some of the outer spaces 64 between adjacent outer fluid treatment elements 12. The features of the fluid treatment elements 12 of the outer set 61, the outer spaces 64, and the outer bands 65 may be similar to those previously described. Again, at least one, and for many embodiments most or all, of the fluid treatment elements 12 of the outer set 61 may have an uneven inflow surface 33 and/or an uneven outflow surface 34. The inner spaces 62 and/or outer spaces 64 may be substantially free of structure or may include one or more structural elements or a functional material, for example, as disclosed in the previously referenced U.S. Provisional Application No. 60/907,069 entitled Fluid Treatment Elements and Fluid Treatment Arrangements with Fluid Treatment Elements Having Different Fluid Treatment Characteristics and Methods for Making and Using Them and the PCT International Application which claims priority based on this Provisional Application.

The inner and outer sets of fluid treatment elements and the inner and outer surrounds may be arranged to direct fluid in series generally axially through one or more outer fluid treatment elements and generally axially through one or more inner fluid treatment elements as the fluid flows from the exterior of the fluid treatment arrangement to the interior of the core assembly or vice versa. For example, in the embodiment of FIG. 13, some of the outer spaces 64A may be open to the exterior of the fluid treatment arrangement 10 and closed along the inner diameters of the outer fluid treatment elements 12 by the inner bands 63. Other outer spaces 64B may be isolated from the exterior of the fluid treatment arrangement 10 by the outer bands 65 and open to the inner spaces 62B along the inner diameter of the outer fluid treatment elements 12. The inner spaces 62B which open onto the outer spaces 64B may be closed along the inner diameter of the inner spaces 62B by a solid wall of the core assembly 11. The inner spaces 62A which are closed by the inner bands 63 may open into the interior 15 of the core assembly 11 though the openings 16 in the core assembly 11.

Fluid treatment arrangements having multiple, radially displaced sets of fluid treatment elements may be contained within a wide variety of housings to provide fluid treatment assemblies, as previously described for the embodiments of FIGS. 1-12.

In one mode of operation feed fluid may be directed through the fluid treatment arrangement 10 along a fluid flow path 50 within a housing between the exterior of the fluid treatment arrangement 9 and the interior 15 of the core assembly 11. For example, in the embodiment of FIG. 13, feed fluid may be directed generally radially into the open outer spaces 64A, further radial flow being blocked by the inner bands 63. From the open outer spaces 64A the feed fluid may flow generally axially through the adjacent outer fluid treatment elements 12 into the outer spaces 64B that are isolated from the exterior of the fluid treatment arrangement 10 by the outer bands 65. As the fluid flows axially through the outer fluid treatment elements 12, the fluid may enter the inflow surface 33 and pass generally edgewise through the fluid treatment medium of each winding. The fluid may also pass from the fluid treatment medium of one winding radially into and then laterally along the fluid treatment medium of one or more adjacent or nearby windings. As the fluid flows through the fluid treatment medium, the fluid is treated in accordance with the fluid treatment characteristic of the medium. The treated fluid exits each outer fluid treatment element 12 through the outflow surface 34. Fluid entering and exiting the fluid treatment elements 12 of the outer set 61 may flow through an uneven inflow surface 33 and/or an uneven outflow surface 34.

Fluid exiting the outer fluid treatment elements 12 may enter the isolated outer spaces 64B. From the isolated outer spaces 64B, the fluid may flow generally radially into the inner spaces 62B that fluidly communicate with the outer spaces 64B, further radial flow being blocked by the solid wall of the core assembly 11. From these inner spaces 62B, the fluid may flow generally axially through the inner fluid treatment elements 12 into the inner spaces 62A that are isolated from the outer spaces 64A by the inner bands 63. As fluid flows axially through the inner fluid treatment elements 12, the fluid may enter the inflow surface 33 and pass generally edgewise through the fluid treatment medium of each winding. The fluid may also pass radially from the fluid treatment medium of one winding into and then laterally along the fluid treatment medium of one or more adjacent or nearby windings. As the fluid flows through the fluid treatment medium, the fluid is treated in accordance with the fluid treatment characteristic of the medium. The treated fluid exits each inner fluid treatment element 12 through the outflow surface 34. Fluid entering and exiting the fluid treatment elements 12 of the inner set 60 may also flow through an uneven inflow surface 33 and/or an uneven outflow surface 34. Fluid exiting the inner fluid treatment elements 12 may enter the inner spaces 62A that are isolated from the outer spaces 64A. From the inner spaces 62A which are isolated from the outer spaces 64A, the fluid may flow generally radially through the openings 16 into the interior 15 of the core assembly 11.

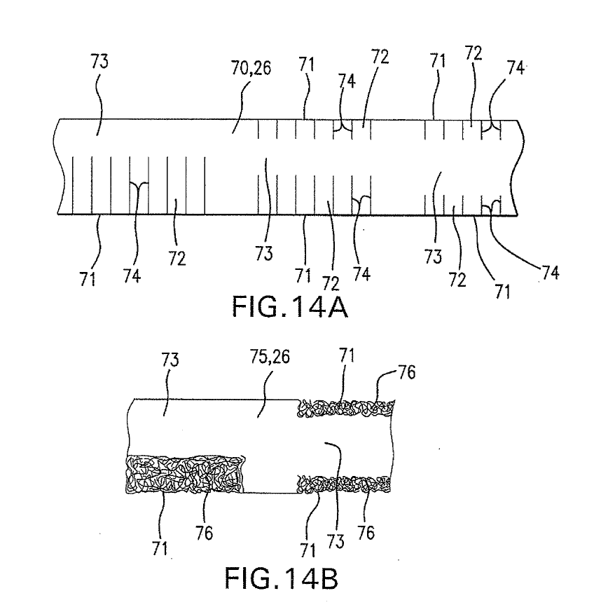

As another example, fluid treatment elements may be formed by spirally winding ribbons, including fluid treatment medium strips, which have been fringed and/or frizzed along one or both side edges of the ribbon. Fringed and frizzed ribbons may be variously configured. For example, as shown in FIG. 14A, a fringed ribbon 70 may include a side edge portion 71 which extends along one or both side edges 24a, 25a of at least the permeable fluid treatment medium 26 and which comprises a plurality of fringe strips 72. The fringe strips 72 may be joined to the base 73 of ribbon 70 including the fluid treatment medium 26 and may extend generally laterally from the base 73 at any of numerous angles less than 90°, 90°, or greater than 90°. The fringe strips 72 may be formed by making cuts 74 in the side edge portions 71. For some embodiments, the fluid treatment medium 26 may be fringed along only one side edge and the cuts 74 may extend from the side edge into the medium 26 up to about 10% or up to about 25% or up to about 50% or up to about 70% or more of the width of the fluid treatment medium 26. For some embodiments, the fluid treatment medium 26 may be fringed along both side edges and the cuts 74 may extend into the medium 26 up to about 10% or up to about 25% or up to about 35% or up to about 50% or more of the width of the medium 26. The width of a fringe strip 72 may vary or may be constant along the length of the ribbon 20. For many embodiments, the width of the fringe strip 72 may be up to 5% or up to 10% or up to 25% or up to 50% or up to 100% or more of the width of the fluid treatment medium 26. The fringed ribbon 70 may be spirally wound in a plurality of windings to form a fluid treatment element; the fluid treatment elements may be mounted along a core assembly to form a fluid treatment arrangement; and the fluid treatment arrangement may be disposed in a housing to form a fluid treatment assembly, all as previously described. Fringing the ribbon 70 may substantially increase the effective surface area of the inflow surface and/or the outflow surface of a fluid treatment element. For example, fringing the ribbon 70 greatly increases the effective surface area of the side edge of the permeable fluid treatment medium 26 because each side edge then includes the outwardly facing axial surfaces of the edge plus the facing surfaces of each cut 74. Fluid may flow into and/or out of all of these side edge surfaces of the fringed ribbon 70 as the fluid flows edgewise through the ribbon.

As another example, a frizzed ribbon 75 may include a side edge portion 71 which extends along one or both side edges of at least the permeable fluid treatment medium 26, and the side edge portion 71 may comprise loosely separated or tufted fibers 76, as shown in FIG. 14B. The tufted fibers 76 may be joined to and extend generally laterally from the base 73 of the fluid treatment medium 26 and may be formed in any of numerous ways, e.g., by carding, combing, or brushing the side edge portion 71 of the fluid treatment medium 26. The frizzed side edge portion 71 of the fluid treatment medium 26 may extend inwardly to the base 73 at least about 5% or at least about 10% or at least about 20% or at least about 30% or more of the width of the fluid treatment medium 26. The frizzed ribbon 75 may be spirally wound in a plurality of windings to form a fluid treatment element; the fluid treatment elements may be mounted along a core assembly to form a fluid treatment arrangement; and the fluid treatment arrangement may be disposed in a housing to form a fluid treatment assembly, all as previously described. Frizzing the ribbon 70 may also substantially increase the effective surface area of the inflow surface and/or the outflow surface of the fluid treatment element.

The present invention is thus not restricted to the particular embodiments which have been described and/or illustrated herein but includes all embodiments and modifications that may fall within the scope of the claims.

1. A fluid treatment arrangement comprising:
a hollow core assembly having an interior;
first and second fluid treatment elements mounted along the core assembly, wherein each fluid treatment element includes a ribbon having a permeable fluid treatment medium spirally wound around the core assembly in a plurality of windings to define a disk-shaped body having a first end surface on one side of the disk-shaped body, a second end surface on the opposite side of the disk-shaped body, and an outer rim and wherein at least one end surface of at least one of the fluid treatment elements includes an uneven surface; and
a fluid flow path which extends between the first and second end surfaces of each fluid treatment element generally edgewise through the permeable fluid treatment medium to or from the interior of the core assembly.

2. The fluid treatment arrangement of claim 1 wherein the ribbon includes first and second opposite major surfaces and first and second opposite side edges and wherein the uneven surface includes a plurality of windings of one of the first and second side edges of the ribbon.

3. The fluid treatment arrangement of claim 2 wherein the uneven surface has an area which is greater than the area of said one of the first and second side edges of the ribbon.

4-9. (canceled)

10. The fluid treatment arrangement of claim 1 wherein each fluid treatment element includes at least one uneven surface.

11. The fluid treatment arrangement of claim 1 wherein an uneven surface comprises an inflow surface.

12-14. (canceled)

15. The fluid treatment arrangement of claim 1 wherein the first fluid treatment element is axially displaced from the second fluid treatment element.

16-19. (canceled)

20. A fluid treatment assembly comprising a housing and a fluid treatment arrangement of claim 1 disposed inside the housing, wherein the housing has first and second ports and defines a fluid flow path between the first and second ports and wherein the fluid flow path which extends between the first and second end surfaces of each fluid treatment element is a portion of the fluid flow path between the first and second ports.

21. A fluid treatment element comprising:
a disk-shaped body including a ribbon having a permeable fluid treatment medium, first and second opposite major surfaces and first and second opposite side edges, wherein the ribbon is spirally wound in a plurality of windings to form the disk-shaped body, wherein the disk-shaped body has a first end surface on one side of the disk-shaped body, a second end surface on the opposite side of the disk-shaped body, and an outer rim, and wherein at least one of the first and second end surfaces includes an uneven surface which includes a plurality of windings of one of the first and second side edges of the ribbon, and
a fluid pathway which extends between the first and second end surfaces generally edgewise through the permeable fluid treatment medium.

22. The fluid treatment element of claim 21 wherein the uneven surface has an area which is greater than the area of said one of the first and second side edges of the ribbon.

23. The fluid treatment element of claim 22 wherein the uneven surface further includes a portion of the first and second major surfaces of the ribbon.

24. The fluid treatment element of claim 21 wherein said one of the first and second side edges comprising the uneven surface includes a plurality of axially extending protrusions spaced along the side edge.

25-28. (canceled)

29. The fluid treatment element of claim 21 wherein an uneven surface comprises an inflow surface.

30-32. (canceled)

33. A method of making a fluid treatment element comprising:
spirally winding a ribbon having a permeable fluid treatment medium in a plurality of windings to form a disk-shaped body having a first end surface, a second end surface opposite the first end surface, and an outer rim, including forming at least one of the first and second end surfaces to include an uneven surface.

34. A method of making a fluid treatment arrangement comprising:
forming a plurality of fluid treatment elements by spirally winding a plurality of ribbons, each having a permeable fluid treatment medium, in a plurality of windings to form disk-shaped bodies, each having first and second opposite end surfaces and an outer rim, including forming at least one end surface of at least one fluid treatment element to include an uneven surface, and
axially positioning the fluid treatment elements along a hollow core assembly.

35-45. (canceled)

46. A method of treating a fluid comprising:
passing fluid through at least one fluid treatment element including a disk-shaped body from a first end surface on one side of the disk-shaped body to a second end surface on the opposite side of the disk-shaped body, wherein at least one of the first and second end surfaces includes an uneven surface, including directing the fluid into and/or out of the uneven surface and further including passing the fluid generally edgewise through a permeable fluid treatment medium of a ribbon spirally wound in a plurality of windings to form the disk-shaped body.

47-52. (canceled)

53. A fluid treatment element comprising:
a disk-shaped body including a ribbon which has a permeable fluid treatment medium and is spirally wound in a plurality of windings to form the disk-shaped body, wherein the permeable fluid treatment medium has first and second opposite major surfaces, first and second opposite side edges, and a side edge portion which is fringed or frizzed and extends along at least one of the first and second side edges, and wherein the disk-shaped body has a first end surface on one side of the body which includes the plurality of windings of the first side edge of the fluid treatment medium, a second end surface on the opposite side of the body which includes the plurality of windings of the second side edge of the fluid treatment medium, an inner rim, and an outer rim.

54-55. (canceled)

56. A fluid treatment arrangement comprising a hollow core assembly having one or more openings and a plurality of fluid treatment elements mounted along the core assembly, the plurality of the fluid treatment elements including a fluid treatment element of claim 53.

57. A fluid treatment assembly including a housing having first and second ports and defining a flow path between the first and second ports and the fluid treatment arrangement of claim 56 disposed in the housing across the fluid flow path.

58. A fluid treatment arrangement comprising a hollow core assembly having one or more openings and a plurality of fluid treatment elements mounted along the core assembly, the plurality of fluid treatment elements including a fluid treatment element of claim 21.

59. A fluid treatment assembly including a housing having first and second ports and defining a flow path between the first and second ports and the fluid treatment arrangement of claim 58 disposed in the housing across the fluid flow path.
